(19) United States
(12) Patent Application Publication
(10) Pub. No.: US 2006/0043318 A1
(43) Pub. Date: Mar. 2, 2006

(54) UV-ray-curing device for curing UV-heat-curable resin in a display panel

(75) Inventor: Hideki Kodera, Kawasaki (JP)

Correspondence Address: Norman P. Soloway;HAYES SOLOWAY PC, 130 W. Cushing Street, Tucson, AZ, 85701, US

(73) Assignee: NEC LCD Technologies, Ltd.

(21) Appl. No.: 11/210,394

(22) Filed: Aug. 24, 2005

(30) Foreign Application Priority Data
Aug. 25, 2004 (JP) 2004-244560

(51) Int. Cl. G01J 3/10

(52) U.S. Cl. 250/504 R

(57) ABSTRACT

A UV-ray-curing device includes a stage for mounting thereon an LC panel having UV-ray-heat curable resin between a TFT substrate and a color-filter substrate for encircling an LC layer, a light source for irradiating the UV-heat-curable resin with UV-rays through a mask having a mask pattern to cure the resin, an elevating device for moving the mask toward the stage to cool the mask after removing the LC panel, and irradiating UV-heat-curable resin in another display panel with UV-rays to cure the resin.

### BACKGROUND OF THE INVENTION

(a) Field of the Invention

The present invention relates to a UV-ray-curing device and a UV-ray-curing method for curing a UV-heat-curable resin in a display panel and, more particularly, to a device and a method for UV-ray-curing a seal resin for sealing a liquid crystal (LC) layer between a pair of substrates.

(b) Description of the Related Art

An LCD device includes a light source for emitting light, and an LC panel having a function of light valve for switching the light emitted by the light source. The LC panel includes, for example, a TFT (thin-film-transistor) substrate wherein an array of pixels each including a TFT and a pixel electrode are formed, a color-filter substrate opposing the TFT substrate and mounting thereon color filters and a common electrode, and an LC layer sandwiched between the TFT substrate and the color-filter substrate. The optical switching function is performed by driving the TFTs to apply voltages between the pixel electrodes and the common electrode to thereby change the orientation of the LC molecules.

Injection of LC between the TFT substrate and the color-filter substrate is generally conducted by using a vacuum injection technique. Before performing the vacuum injection, the above-described two substrates are first prepared, followed by coating a heat-curable resin on one of the substrates to form an annular sealing pattern except for an injection port. Subsequently, spacers are scattered on any one of the substrates, both the substrates are overlapped with one another, and the heat-curable resin is cured using a heat treatment to adhere both the substrates together. Thereafter, LC is injected through the injection port by using a capillary phenomenon, followed by plugging the injection port.

Due to the recent tendency of increase in the dimensions and performance of the LC panel, the LC panel is requested to have a smaller cell gap between both the substrates. In such a smaller cell-gap LC panel, the vacuum injection process consumes a longer time period to thereby degrade the productivity of the LC panel, i.e., increases the turn-around-time of the LC panel. Thus, another technique known as an LC drip technique and shown in FIGS. 4A to 4F is increasingly used.

Before performing an LC drip process, the TFT substrate 11 and the color-filter substrate 12 each having thereon an orientation film (not shown) for aligning orientation of the LC molecules are prepared, as shown in FIG. 4A, and received in a vacuum chamber. One of the substrates, for example, the TFT substrate 11 is coated with seal resin 13 to form an annular sealing pattern without an injection port in an atmospheric pressure. A plurality of droplets of LC 14 are then supplied onto the other substrate, i.e., color-filter substrate 12, although a single droplet is depicted in FIG. 4B. The seal resin 13 may be a UV-curable resin, or a UV-heat-curable resin which is curable by using either or both of UV rays and a heat treatment. The UV-curable resin or UV-heat-curable resin has an advantage that these resins can be cured in a short time period to prevent the LC from being contaminated.

In the following description, the case of using the UV-curable resin is exemplarily described. A number of spacers 15 having a specified dimension are scattered onto one of both the substrates 11 and 12, followed by evacuating the internal of the vacuum chamber and overlapping both the substrates 11 and 12 together to form an LC panel structure, as shown in FIG. 4C. In the overlapping step, the LC 14 is not contacted with the seal resin for avoiding contamination of the LC 14 by the seal resin 13.

Thereafter, the pressure inside the vacuum chamber is restored to an atmospheric pressure, whereby both the substrates 11 and 12 are pressed toward each other from outside the LC panel by the atmospheric pressure shown by arrows “A” in FIG. 4D. This pressure allows both the substrates 11 and 12 to have an equal gap therebetween and thus allows the LC 14 to be distributed equally in the cell gap between the substrates 11 and 12. The atmospheric pressure may be associated with a pressure plate for pressing both the substrates together. The gap distance is determined by the spacers 15 scattered in the gap, and is 3 to 7 micrometers, for example.

Thereafter, the resultant LC panel is irradiated with UV rays 45 on the TFT substrate 11 through a mask 42, as shown in FIG. 4E. The mask 42 includes a transparent substrate 43, and a light-shield film pattern 44 made from an aluminum film formed thereon. The light-shield film pattern 44 has an annular opening 44a corresponding to the location of the stripe of the seal resin 13.

The mask 42 used for the UV-ray irradiation prevents adverse affects caused by irradiation of the display area of the LC panel by the UV-rays, the adverse affects degrading the characteristics of the TFTs and changing the initial orientation of the LC molecules. Prevention of the irradiation of the display area by the UV-rays may be performed by disposing the LC panel so that the color-filter substrate 12 is located topside, with the TFT substrate 11 being bottom side, thereby allowing the color filters to absorb the UV-rays. However, in this situation, the annular seal resin should be disposed outside the color filters, whereby the LC panel has a larger planar size.

The UV-ray irradiation is performed using a light source 20 having an intensity of 100 milli-watts(mW)/cm² for a time length of 120 seconds, for example. The UV-ray irradiation generally cures the seal resin 13 at the surface portion thereof, thereby temporarily fixing together both the substrates 11 and 12, if a UV-heat-curable resin is used for the seal resin. The distance between the LC panel and the mask 42 is about 1 mm or smaller, and may be in direct contact with one another.

The seal resin 13 is then subjected to a heat treatment at a temperature above the curing temperature for the UV-heat-curable resin, thereby finally curing the seal resin. The curing temperature for the UV-heat-curable resin is about 40 degrees C. or above, and may be conducted at a temperature of 120 degrees C. for about 60 minutes, for example. This heat treatment completes the LC panel 10 shown in FIG. 4F.

As described above, the LC drip technique obviates the LC injection step and the plugging step for the injection hole, which complicated the vacuum injection technique, thereby simplifying the process for manufacturing the LC panel. In addition, since the LC drip technique has the step of curing the seal resin 13 with the cell gap being maintained at a suitable distance, the accurate distance can be obtained for the cell gap. Thus, the LC drip technique can be suitably used particularly for manufacturing an in-plane-switching-mode (IPS) LCD device, which requires a higher accuracy for the cell gap.

FIG. 5 shows a UV-ray irradiation equipment using the process shown in FIGS. 4A to 4F in a system for manufacturing LCD devices. The UV-ray irradiation equipment includes a light source 20 for emitting UV-rays, a stage 30 for mounting thereon an LC panel 10, and a mask holder 41 for mounting thereon a mask 42 between the light source 20 and the LC panel 10 on the stage 30. The light source 20 includes a UV-lamp 21 for generating UV-rays, and a lamp housing 22 for collimating the UV-rays to irradiate the UV-rays toward the stage 30. The mask holder 41 has a shape of rectangular frame.

FIG. 6 shows a process for manufacturing LC panels by using the UV-ray irradiation equipment shown in FIG. 5. An LC panel 10 having seal resin 13 applied onto one of the substrates 11 and 12 is mounted on the stage 30 (step A1). The location of the mask 42 mounted on the mask holder 41 is then adjusted so that the pattern 44 of the mask 42 is aligned with the seal resin of the LC panel 10 and the distance between the mask 42 and the LC panel 10 is determined at a suitable distance (step A2). The alignment can be achieved in a few tens of seconds by aligning, in a horizontal direction, an alignment mark formed on the LC panel with another alignment mark formed on the mask 42.

Thereafter, the light source 20 is turned on to emit UV-rays as shown in FIG. 4E (step A3). The resultant LC panel 10 is then removed from the stage (step A4), returning to the step A1 to iterate steps Al to A4 for curing the seal resin in another LC panel. The LC drip technique as described above is described in Patent Publication JP-A-2003-241206, for example.

In the LC drip technique as described above has a disadvantage in that the UV-ray irradiation partly advances the step of locally heat-curing the seal resin in addition to the UV-curing. This local heat-curing step advances as follows. In the UV-ray irradiation of step A3, the mask 42 absorbs part of the light emitted from the light source 20, and is heated to some extent. The temperature of the mask 42 thus heated may exceed the heat-curing temperature of the seal resin. Thus, the seal resin of a next LC panel 10 mounted on the stage 30 may be heated by the mask 42 at the curing temperature or above via a heat radiation or convection from the mask 42.

The local curing of the seal resin generates different degrees of hardness and viscosity in different locations of the seal resin. The different degrees of hardness and viscosity generate different stresses in the seal resin, thereby causing an uneven cell gap between the substrates 11 and 12, which degrades the image quality of the LC panel 10.

In order for suppressing the temperature rise of the mask 42 during the UV-ray irradiation step, a cooling device for cooling the mask 42 may be provided in the UV-ray-curing equipment. A heat-ray-cutting filter may also be provided between the mask and the LC panel in addition to the cooling device for suppressing the temperature rise of the mask 42. However, these techniques achieved only limited suppressions, which were not enough according to the experiments by the inventor.

In addition, if the UV-curing step for curing the seal resin is performed through the TFT substrate, then the UV-rays are intercepted by the TFTs, wires such as gate lines and data lines on the TFT substrates, and thus a larger irradiation energy is required to increase the temperature rise of the mask.

In the experiments, UV-ray irradiation through the TFT substrate required an irradiation energy four times as high as the irradiation energy used in the UV-ray irradiation through the color-filter substrate, which was about 3 joules /cm². The temperature rise of the mask 42 measured in the UV-ray irradiation through the TFT substrate was about 5 degrees C. and exceeded the curing temperature of the seal resin.

In summary, the UV-ray irradiation of the UV-heat-curable resin in the LC panels involves a problem of the local curing of the seal resin after iterated UV-ray irradiation, thereby causing an uneven cell gap in the LC panels.

### SUMMARY OF THE INVENTION

In view of the above problems in the conventional techniques, it is an object of the present invention to provide UV-ray-curing device and method for curing UV-heat-curable resin.

The present invention provides a UV-ray-curing device for UV-ray-curing a UV-heat-curable resin in a display panel, including: a stage for mounting thereon the display panel; a mask holder mounting thereon a mask having a mask pattern; a light source irradiating the display panel with UV-rays through the mask; a moving device moving the mask holder with respect to the stage to allow the mask on the mask holder in contact with or in a proximity of the stage when the stage mounts thereon no display panel.

The present invention also provides a method consecutively including: mounting on a stage a display panel having therein a UV-heat-curable resin; irradiating the UV-heat-curable resin in the display panel on the stage with UV-rays through a mask having a mask pattern, to cure the UV-heat-curable resin; removing the display panel from the stage; moving the mask with respect to the stage to allow the mask pattern in contact with or in a proximity of the stage; mounting on the stage another display panel having therein a UV-heat-curable resin; and irradiating the UV-heat-curable resin in the another display panel on the stage with UV-rays through the mask to cure the UV-heat-curable resin.

In accordance with the device and method of the present invention, since the heat of the mask is removed by the stage having a large heat capacity, the local curing of the UV-heat-curable resin during the UV-ray irradiation can be avoided without a large interval between the iterated UV-ray irradiation.

The above and other objects, features and advantages of the present invention will be more apparent from the following description, referring to the accompanying drawings.

### BRIEF DESCRIPTION OF THE DRAWINGS

FIG. 1 is a sectional view of a UV-ray-curing device for curing seal resin in an LC panel according to an embodiment of the present invention.

FIG. 2 is another section view of the UV-ray-curing device of FIG. 1 in the state of the mask holder being disposed in the proximity of the stage.

FIG. 3 is a flowchart of a method used in the UV-ray-curing device of FIG. 1, for UV-ray-curing the seal resin in the LC panel.

FIGS. 4A to 4F are sectional views of an LC panel during manufacture thereof using an LC drip technique.

FIG. 5 is a UV-ray-curing device for curing the seal resin in an LC panel.

FIG. 6 is a flowchart of a UV-ray-curing process used in the UV-ray-curing device of FIG. 5.

### PREFERRED EMBODIMENT OF THE INVENTION

Before describing preferred embodiment of the present invention, the study conducted by the present inventor for solving the above problem will be described. Examples of the methods for cooling the heated mask include waiting the next curing step until the heated mask is eventually cooled, and forcibly cooling the mask prior to UV-ray-curing the seal resin in the next LC panel while removing the mask from the mask holder. It is noted here that these methods consume longer time periods thereby increasing a turn-around-time of the curing.

The present inventor conceived to use the stage for mounting the LC panel and having a large heat capacity as a cooling device for cooling the mask. More specifically, it was noted that the mask could be cooled by moving the mask toward the vicinity of the stage, after the step of UV-ray irradiation (step A3) and before the step of mounting the next LC panel (step A1) on the stage in FIG. 6. The proximity of the mask with respect to the stage cools the mask by a heat convection. More effectively, the mask may be moved to contact the surface of the stage to cool the mask by a heat conduction.

In the experiments, it was confirmed that the distance below 1 millimeter was sufficient to effectively cool the mask before mounting the next LC panel on the stage. A cooling device for cooling the stage by using a cooling water was more effective to cool the mask.

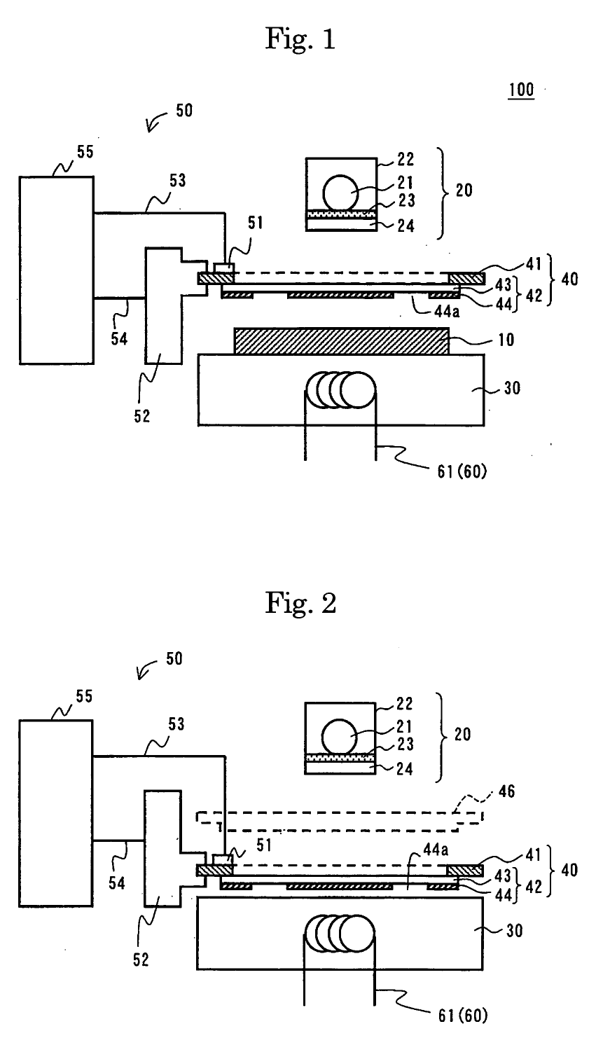

Now, the present invention is more specifically described with reference to accompanying drawings. Referring to FIG. 1, a UV-ray-curing device, generally designated by numeral 100, according to an embodiment of the present invention includes a light source 20 for generating UV-rays, a lamp housing 22 for collimating the UV-rays generated by the light source 20 to irradiate the parallel UV-rays, a heat-ray-cutting filter 23 for removing heat rays from the UV-rays, a shutter 24 for passing the UV-rays during a UV-ray exposure step, and an elevating device 50 for lifting and lowering the mask holder 41 with respect to the stage 30.

The stage 30 is made from a metal such as aluminum or iron, and has a flat top surface. The stage 30 includes therein a water-cooling device 60 including a tube 61 installed inside the stage 30 for cooling the stage by a cooling water flowing within the tube 61.

The mask holder 41 has a shape of frame and mounts thereon a mask 42 fixed thereto. The mask 42 is about 0.7-mm thick, and includes a transparent substrate 43 made of glass, and a light-shield film pattern 44 formed on the transparent substrate 43. The light-shield film pattern 44 has an annular opening 44a corresponding to the location of the seal resin 13 applied onto the TFT substrate 11.

The elevating device 50 includes a temperature sensor 51 disposed on the mask holder 41 for detecting the temperature of the mask 42, an elevating mechanism 52 for lifting and lowering the mask holder 41, and a controller 55 connected to the temperature sensor 51 and the elevating mechanism 52 via signal lines 53 and 54 for controlling the operation of the elevating mechanism 52. The controller 55 is implemented by a personal computer or a microcomputer, and lifts and lowers the mask holder 41 based on a specific time schedule during a time period when the stage 30 mounts thereon no LC panel 10. The mask 42 is in contact with the top surface of the stage 30 at the lowest position of the mask holder 41, or may be in the most proximity with respect to the stage 30. The dotted line 46 denotes the location of the mask holder 41 and the mask 42 during a UV-ray irradiation procedure.

The controller 55 monitors the temperature of the mask 42 via the temperature sensor 51, intermittently lowers the mask holder 41 to contact the stage 30, and lifts the mask holder 41 from the stage 30 after the temperature of the mask 42 is lowered below a specific low temperature. In an alternative, or in addition thereto, the controller 55 may lower the mask holder 41 toward the stage 30 if the temperature of the mask 42 rises above a specific high temperature.

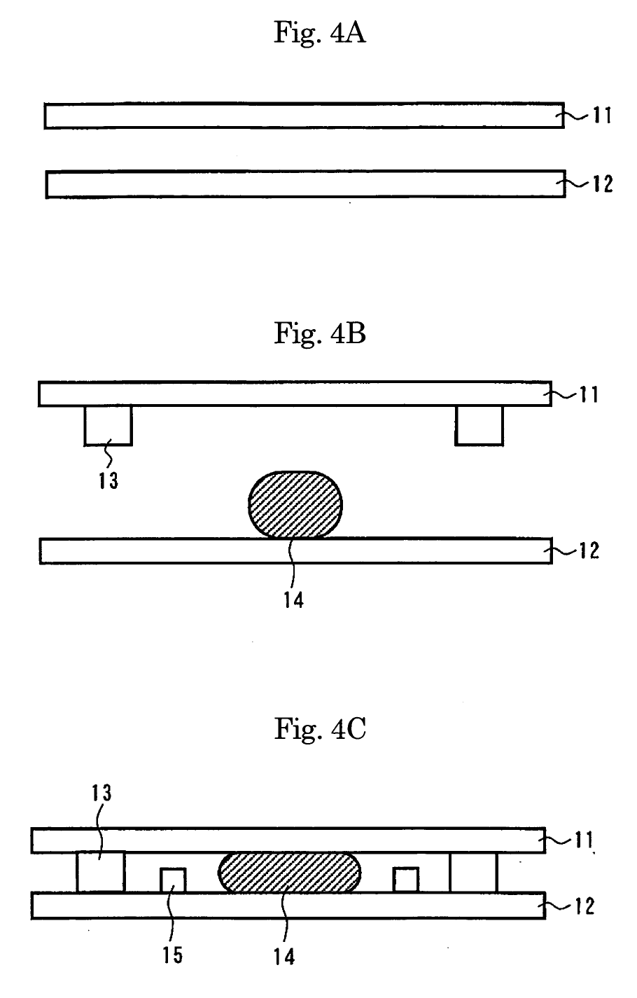

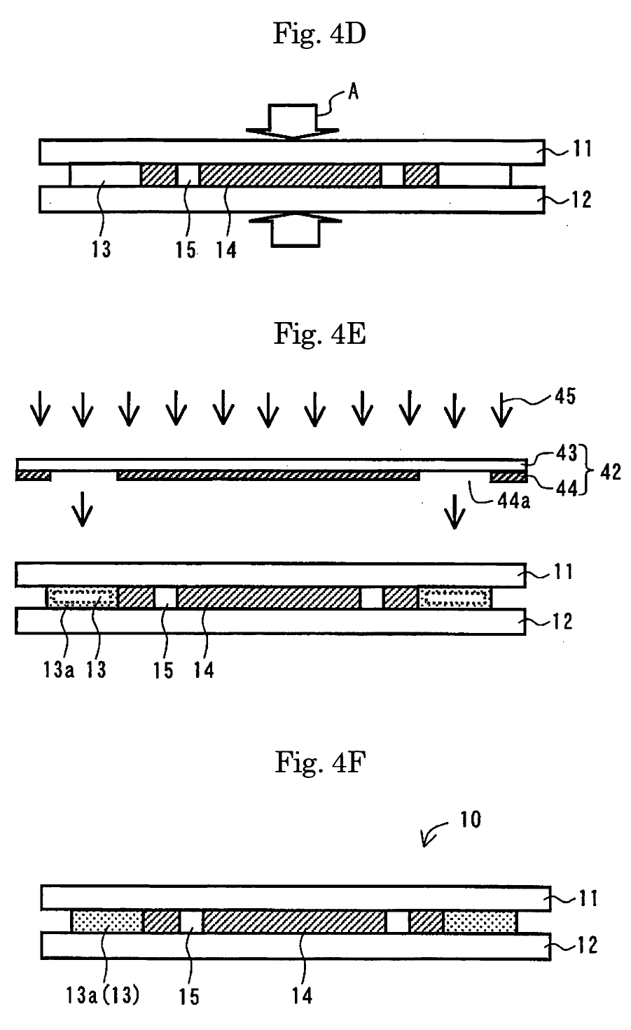

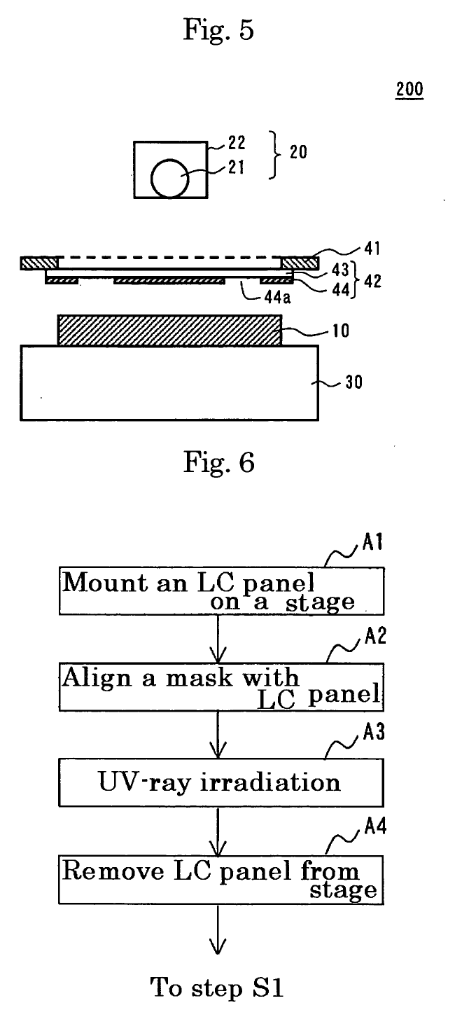

The LC panel manufactured using the UV-ray irradiation device 100 of the present embodiment, as shown in FIG. 4F, includes a TFT substrate 11, a color-filter substrate 12, an LC layer sandwiched between the TFT substrate 11 and the color-filter substrate 1, seal resin 13 made of a UV-heat-curable resin. The seal resin 13 encircles the LC layer within the gap between the TFT substrate 11 and the color-filter substrate 12. The LC panel 10 includes spacers 15 scattered in the LC layer, or in the gap between the TFT substrate 11 and the color-filter substrate 12. The LC panel 10 may be manufactured by the process shown in FIGS. 4A to 4F.

The seal resin 13, i.e., UV-heat-curable resin includes therein epoxy resin and acrylic resin as main components thereof. The irradiation energy required for UV-ray-curing the seal resin is about 3 to 12 joules/cm², and is obtained by a light source having an irradiation intensity of 100 milliwatts/cm² and operating for a time length of about 120 seconds. The heat curing step is conducted at a temperature of about 120 degrees C. for about 60 minutes, for example. The temperature above which the curing is effected is about 40 degrees C. at the minimum.

The UV-ray-curing device 100 of the present embodiment is provided with an elevating device 50 which raises and lowers the mask holder 41 with respect to the stage 30, and cools the mask 42 by using the stage 30 while taking advantage of the large heat capacity of the stage 30. This suppresses the heat-curing of the UV-heat-curable resin caused by the heat of the mask 42, without necessitating a long interval between the UV-ray irradiation of an LC panel and the UV-ray irradiation of a next LC panel. This increases the turn-around-time of the manufacture of LCD devices. The water-cooling device 60 assists the stage 30 to more effectively cool the mask 42.

The suppression of the heat curing of the UV-ray-heat curable resin during the UV-ray irradiation provides uniform hardness and uniform viscosity of the UV-heat-curable resin after the UV-ray irradiation. Thus, the heat-curing step allows the LC panel to be applied with a uniform stress from the seal resin, whereby the resultant LC panel has a uniform gap between the substrates 11 and 12 and thus has an excellent image quality.

In the above embodiment, the mask holder 41 is moved toward and away from the stage 30. In an alternative, the stage 30 may be moved toward and away from the mask holder. The temperature sensor 51 may detect the temperature of the mask 42 by sensing the temperature of the ambient air flowing in the vicinity of the mask 42. The UV-ray irradiation procedure may use a mask 42 which exposes therethrough one or a plurality of LC panels to the UV-rays, for example, tens of LC panels. The transparent substrate 43 of the mask 42 may be reinforced plastics instead of glass.

The heat of the mask 42 is particularly conducted from mask 42 to the stage 30 if the distance therebetween is 1 mm or less. Thus, the elevating device 50 should allow the distance between the mask 42 and the stage 30 to be 1 mm or less.

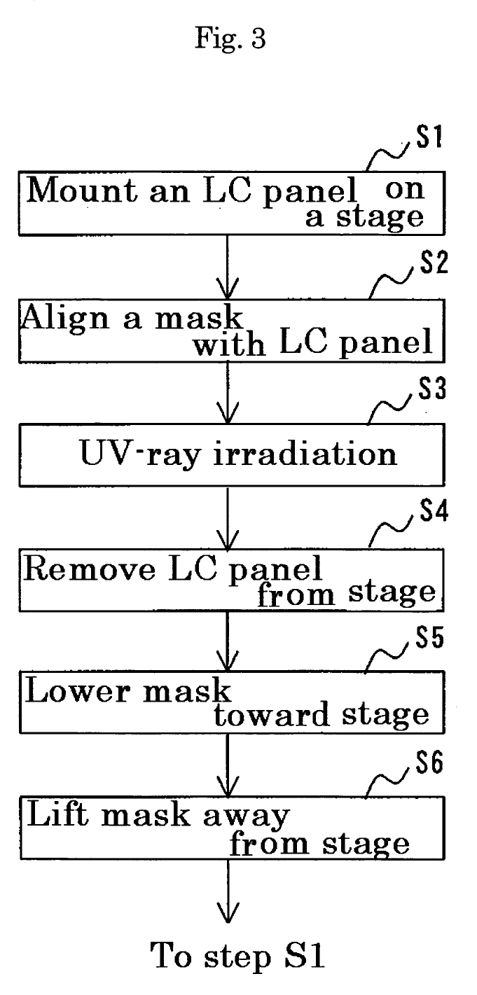

FIG. 3 shows a process for UV-ray irradiation used in the UV-ray irradiating device of the above embodiment. In the process, an LC panel 10 wherein a seal resin is applied onto one of the TFT substrate 11 and color-filter substrate 12 are is mounted on the stage 30 (step S1). Thereafter, the mask 42 is aligned with the LC panel 10 in the horizontal direction by using a known technique (step S2). The alignment generally consumes about 20 to 30 seconds. Subsequently, UV-ray irradiation is conducted onto the LC panel 10 through the mask 42 (step S3). The UV-ray irradiation allows the surface portion of the seal resin 13 to be cured and temporarily fix both the substrates 11 and 12 together. The resultant LC panel 10 is removed from the stage 30 (step S4).

Thereafter, as shown in FIG. 2, the elevating device 50 moves the mask holder 41 toward the stage 30 to allow the mask 42 to be in contact with the top surface of the stage 30, or to allow the mask to be in the proximity of the top surface of the stage 30 with a gap therebetween equal to about 0.5 mm. The elevating device 50 maintains the mask 42 in this state for about 20 seconds (step S5). In this state, the mask 42 is effectively cooled by the stage 30 due to the large heat capacity of the stage 30. The mask 42 is cooled below about 20 degrees C., for example, which is well below the heat-curing temperature, 40 degrees C., of the UV-heat-curable resin. The elevating device 50 then raises the mask holder 41 (step S6), and iterates the steps S1 to S6 for a next LC panel 10 to cure the UV-heat-curable resin therein.

According to the method of the embodiment of the present invention, since the mask 42 is maintained in the proximity of the stage 30, within a distance of 1 mm, after the cured LC panel 10 is removed and before the next LC panel 10 is provided, the mask 42 can be effectively cooled for suppressing the heat-curing of the seal resin 13 in the next LC panel 10.

The direct contact of the mask 42 with respect to the stage 30 can more effectively cool the mask 42 by using heat conduction instead of the heat convection. It is to be noted that the present invention can be applied to manufacture of other display panels, such as a plasma display panel, in addition to the LC panel.

Since the above embodiments are described only for examples, the present invention is not limited to the above embodiments and various modifications or alterations can be easily made therefrom by those skilled in the art without departing from the scope of the present invention.

What is claimed is:

1. A UV-ray-curing device for UV-ray-curing a UV-heat-curable resin in a display panel, comprising:
a stage for mounting thereon the display panel;
a mask holder mounting thereon a mask having a mask pattern;
a light source irradiating the display panel with UV-rays through said mask;
a moving device moving said mask holder with respect to said stage to allow said mask on said mask holder in contact with or in a proximity of said stage when said stage mounts thereon no display panel.

2. The UV-ray-curing device according to claim 1, wherein said stage comprises a cooling device for cooling said stage.

3. The UV-ray-curing device according to claim 1, wherein a distance between said mask and said stage is equal to or less than 1 mm when said stage mounts thereon no display panel.

4. The UV-ray-curing device according to claim 1, further comprising a temperature sensor for detecting a temperature of said mask, and a controller for controlling said moving device to maintain said mask in said contact with or proximity of said stage if a temperature of said mask is equal to or above a specific temperature.

5. A method consecutively comprising:
mounting on a stage a display panel having therein a UV-heat-curable resin;
irradiating said UV-heat-curable resin in said display panel on said stage with UV-rays through a mask having a mask pattern, to cure said UV-heat-curable resin;
removing said display panel from said stage;
moving said mask with respect to said stage to allow said mask pattern in contact with or in a proximity of said stage;
mounting on said stage another display panel having therein a UV-heat-curable resin; and
irradiating said UV-heat-curable resin in said another display panel on said stage with UV-rays through said mask to cure said UV-heat-curable resin.

6. The method according to claim 5, wherein said moving said mask allows a distance between said mask and said stage to be 0 to 1 mm.

7. The method according to claim 5, further comprising: detecting a temperature of said mask; and maintaining said mask in said contact with or in said proximity of said stage until said detected temperature becomes below a specific temperature.
